(19) United States
(12) Patent Application Publication
(10) Pub. No.: US 2016/0364684 A1
(43) Pub. Date: Dec. 15, 2016

(54) INCREMENTAL ESTIMATION FOR PROBABILISTIC FORECASTER

(71) Applicant: MICROSOFT TECHNOLOGY LICENSING, LLC, Redmond, WA (US)

(72) Inventors: Rekha Nanda, Redmond, WA (US); Yanfang Shen, Bellevue, WA (US); Peeyush Kumar, Seattle, WA (US); Wolf Kohn, Seattle, WA (US); Philip Placek, Seattle, WA (US)

(21) Appl. No.: 14/813,858

(22) Filed: Jul. 30, 2015

Related U.S. Application Data
(60) Provisional application No. 62/180,002, filed on Jun. 15, 2015.

(51) Int. Cl. G06Q 10/08

(52) U.S. Cl. CPC G06Q 10/087; G06Q 10/083

(57) ABSTRACT

Technologies are described to provide parameter estimation for a probabilistic forecaster in inventory management. A forecaster model may be generated based on observed delivery data, demand data, and a state of a delivery system managed by an inventory management service or an enterprise resource planning service. A probability of the state of the delivery system transitioning to a subsequent state of the delivery system may be determined based on an estimation of one or more parameters using a linear regression model. In some examples, the forecaster model may be derived from the discretized version of the linear Fokker-Planck equations using maximum log-likelihood estimate with optimization through a fast marching algorithm. In other examples, Lagrange multipliers may be used to determine initial constraints on the parameters. An optimal inventory level to be maintained may be computed based on the determined probability.

### CROSS-REFERENCE TO RELATED APPLICATION

This application claims benefit under 35 U.S.C §119 (e) of U.S. Provisional Application Ser. No. 62/180,002 filed on Jun. 15, 2015. The Provisional application is herein incorporated by reference in its entirety.

### BACKGROUND

Inventory management is primarily about specifying the shape and percentage of stocked goods. It may be implemented at different locations within a facility or within many locations of a supply network to precede the regular and planned course of production and stock of materials. The scope of inventory management may include the fine lines between replenishment lead-time, carrying costs of inventory, asset management, inventory forecasting, inventory valuation, inventory visibility, future inventory price forecasting, physical inventory, available physical space for inventory, quality management, replenishment, returns and defective goods, assortment planning and demand forecasting. Balancing these competing requirements may lead to optimal inventory levels, which is an ongoing process as the business needs shift and react to the wider environment.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

According to some embodiments, a forecaster model may be generated by an inventory management service or an enterprise resource planning service based on observed delivery data, demand data, and a state of a delivery system. A probability of the state of the delivery system transitioning to a subsequent state of the delivery system may be determined based on an estimation of one or more parameters using a linear regression model. An inventory level to be maintained may then be determined based on the determined probability, and information associated with the determined inventory level to be maintained may be provided to one or more inventory management systems.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1A illustrates an overview of a cloud-based inventory management system according to embodiments;

FIG. 1B illustrates an example of single item probability demand forecast in the cloud;

FIG. 2 illustrates a detailed overview of a system according to embodiments:

FIG. 3A illustrates example selection of boundaries at different states of a delivery system;

FIG. 3B illustrates an example of cloud implementation for offline training;

FIG. 4 is an example networked environment, arranged in accordance with at least some embodiments described herein;

FIG. 5 illustrates a general purpose computing device, which may be configured to provide parameter estimation for a probabilistic forecaster in inventory management, arranged in accordance with at least some embodiments described herein;

FIG. 6 illustrates a logic flow diagram for an example process to provide parameter estimation for a probabilistic forecaster in inventory management, arranged in accordance with at least some embodiments described herein; and

FIG. 7 illustrates a flowchart for an example modified fast marching algorithm.

### DETAILED DESCRIPTION

As briefly stated above, a forecaster model may be generated based on observed delivery data, demand data, and a state of a delivery system managed by an inventory management service or an enterprise resource planning service. A probability of the state of the delivery system transitioning to a subsequent state of the delivery system may be determined based on an estimation of one or more parameters using a linear regression model. In some examples, the forecaster model may be derived from the discretized version of the linear Fokker-Planck equations using maximum log-likelihood estimate with optimization through a fast marching algorithm. In other examples, Lagrange multipliers may be used to determine initial constraints on the parameters. An optimal inventory level to be maintained may be computed based on the determined probability. The incremental estimation for probabilistic forecaster is applicable in inventory management.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, and a memory chip, among others. The computer-readable storage medium can for example be implemented via one or more of a volatile computer memory, a non-volatile memory, a hard drive, and a flash drive.

Throughout this specification, the term “platform” may be a combination of software and hardware components to provide an inventory management service. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example embodiments may be found in the following description.

The technical advantages of providing incremental parameter estimation for the probabilistic forecaster may include increased system efficiency resulting from reduced complexity of computation (linear complex computation), which may lead to reduced processor load, reduced memory load, and reduced network bandwidth usage (less data to exchange). Furthermore, network delay and latency may also be reduced as a result of reduced complexity of computations. In a system according to embodiments, distribution is learned not assumed, thus, accuracy is increased while computation complexity is reduced, thereby enabling increased user interaction efficiency. Moreover, a system according to embodiments is extensible enabling ERP system-wide increase of efficiency.

Embodiments, as described herein, address a need that arises from large scale of operations created by cloud-based inventory services that cannot be managed by humans. The actions/operations described herein are not a mere use of a computer, but address results of a system that is a direct consequence of software used as a service offered in conjunction with large numbers of users and applications.

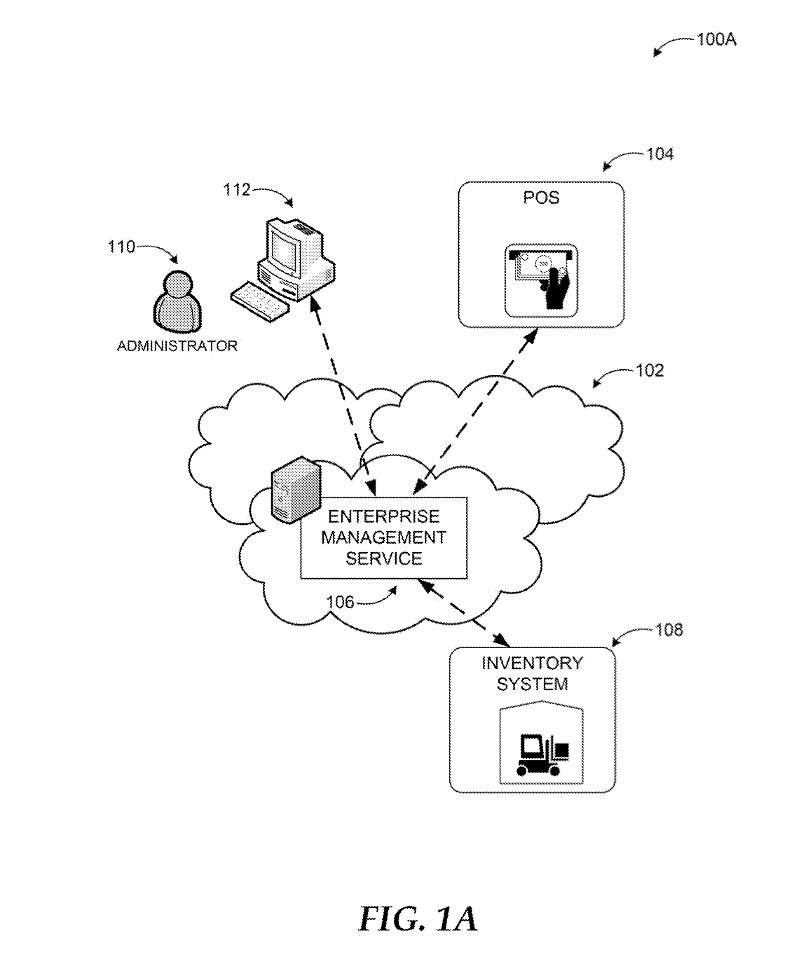

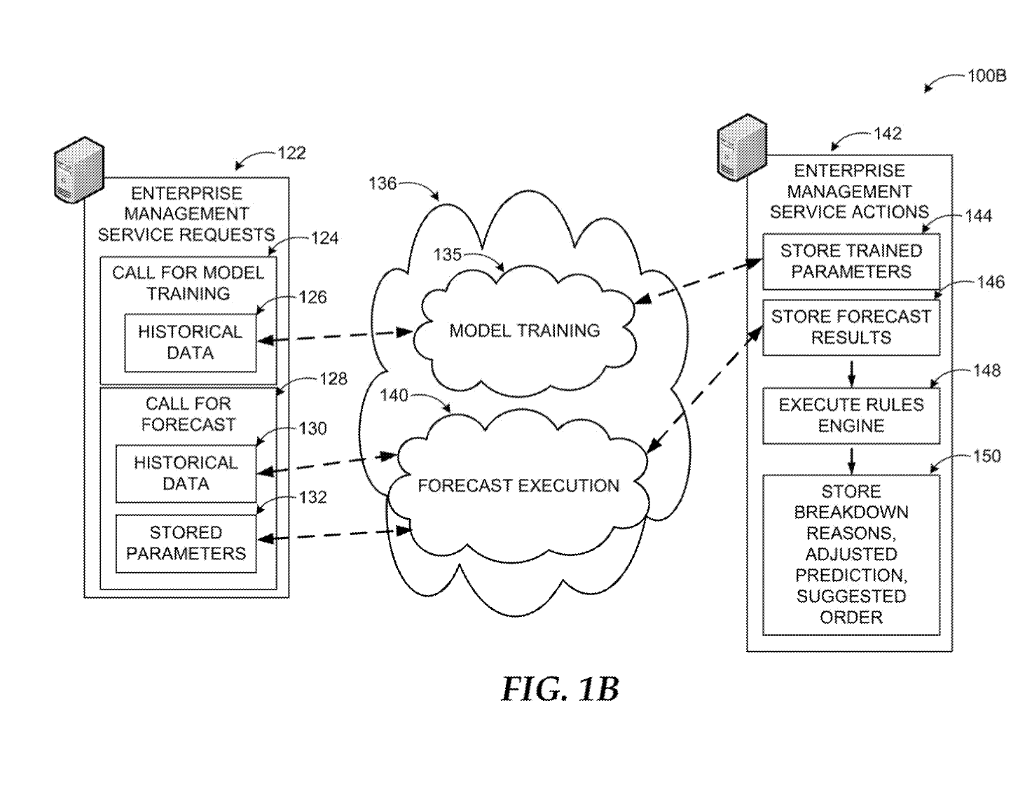

FIG. 1A illustrates an overview of a cloud-based inventory management system according to embodiments.

In diagram 100A, an enterprise management service 106 is shown as implemented on cloud 102 utilizing one or more networks. An administrator 110 may provide initial configuration parameters, monitor inventory management operations, receive or redirect reports, and perform other management tasks. An inventory system 108 communicatively coupled to the enterprise management service 106 may manage inventory, schedule deliveries, place inventory replenishment orders, and perform comparable tasks in one or more inventory locations (e.g., warehouses). A point-of-sale (POS) 104 entity may represent retail locations, for example, that receive inventory, observe and report demand, and receive management services from the enterprise management service 106.

Inventory management as part of enterprise resource planning may be implemented at different locations within a facility or within many locations of a supply network to precede the regular and planned course of production and stock of materials. Balancing various competing requirements within the scope of inventory management for optimal inventory levels may be an ongoing process as the business needs shift and react to the wider environment. In a system according to embodiments, a forecaster model may be derived from a discretized version of the linear Fokker-Planck equations using maximum log-likelihood estimate with optimization through a fast marching algorithm. Lagrange multipliers may be used to determine initial constraints on the parameters, and an optimal inventory level to be maintained may be computed based on a determined probability of a state of the delivery system to transition to another state.

FIG. 1B illustrates an example of single item probability demand forecast in the cloud.

As shown in diagram 100B, demand forecast computation may be performed on one or more dedicated servers on a cloud 136. Two components, model training 135 and forecast execution 140 may be implemented. Model training 135 may be for incremental probability propagator and execute a parameters optimizer (employing a fast marching algorithm with an I-frame, for example). The forecast execution 140 may provide the demand probability forecast. As shown in the diagram, enterprise management service requests 122 may include a call for model training 124 and a call for forecast 128. The call for model training 124 may be for a single item with an identifier, for example, and include historical data 126 for the single item. The call for forecast 128 may also be for the single item and provide a date and a forecast period for the requested forecast. The call for forecast 128 may include historical data 130 for the single item up the specified date and stored parameters 132 for the single item.

Enterprise management service actions 142 may include storing trained parameters (144) for the single item, storing forecast results (146) for the single item, and executing a rules engine for the single item. The execution of the rules engine may also involve and external service. As a result of the execution of the rules engine, data associated with why (if) there was a facility breakdown, adjusted prediction, and a suggested order for the single item may be stored (150). While the example requests and actions are discussed in conjunction with a single item, multiple items may also be used in the forecast of demand probability.

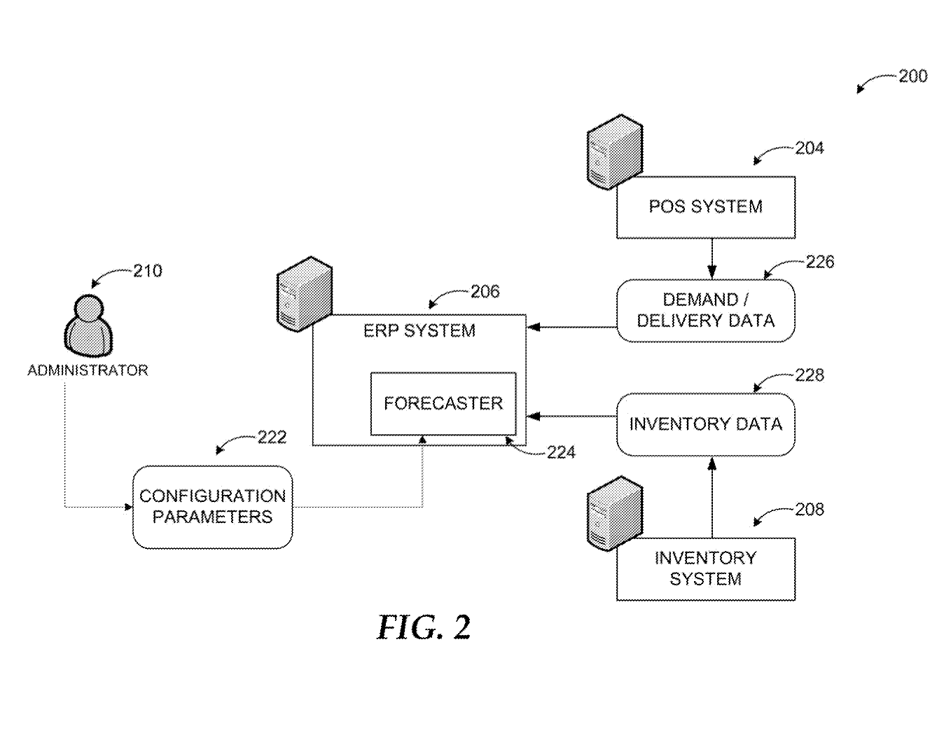

FIG. 2 illustrates a detailed overview of a system according to embodiments.

Diagram 200 shows in a simplified and conceptualized manner exchange of information among major components of a system according to embodiments. As mentioned above, administrator 210 may provide configuration parameters 222 to a forecaster module 224 of an ERP system 206, among other things. The ERP system 206 may receive demand and actual delivery data 226 from a POS system 204 and inventory data 228 from an inventory system 208. The forecaster module 224 may estimate one or more parameters using a linear regression model and compute a probability of the state of the delivery system transitioning to a subsequent state. The ERP system 206 may, based on the computed probability, determine an optimal inventory level to be maintained/delivered to the POS system 204. The ERP system 206 may then provide information associated with the optimal inventory level to be maintained to the inventory system 208 for inventory management operations (e.g., shipment scheduling, replenishment, storage operations, etc.).

Determination of the optimal inventory level to be maintained based on forecaster model described herein may be performed by an inventory management service or an ERP service. In some examples, the inventory management service may be a part of an ERP service. The ERP system 206 in diagram 200 is an example of an integrated service, where a number of task specific modules or applications may be executed on a number of servers and similar computing devices and communicating over one or more networks provide cloud-based services.

The incremental estimation for probabilistic forecaster may provide a method for optimizing parameter generation using a probability model. The forecaster model may be derived from the discretized version of the linear Fokker-Planck equations. Given to observations:

$${y}_{t} = [ \begin{matrix}{POS}_{t} \\ Delivery {data}_{t}\end{matrix} ] \qquad [ 1 ]$$

and a state of the system:

$${x}_{t} = [ \begin{matrix}{Demand}_{t} \\ {Inventory}_{t} \\ {Delivery}_{t}\end{matrix} ] \qquad [ 2 ]$$

at time t, the goal is to find parameters of the Fokker-Planck equations so that a forecaster model fits the known data. The state of the system, xₜ, may be approximated by letting Demandₜ=POSₜ, and the inventory level, for daily delivery, to be Deliveryₜ−POSₜ. The parameters to estimate may be the 1×3 vector functions Sᵢ(Δxₜ, t), denoted {S}, and the 15 functions of aᵢⱼ(Δxₜ, t), aᵢⱼ⁻(Δxₜ, t), aᵢⱼ⁺(Δxₜ, t). Let A be the set of all these 15 functions, A={aᵢⱼ(Δxₜ, t), aᵢⱼ⁻(Δxₜ, t), aᵢⱼ⁺(Δxₜ, t)}. To estimate the parameters, {A, S}, maximum log-likelihood estimate may be used with optimization using the fast marching algorithm.

In some examples, the probability propagator forecaster model may be derived from the discretized version of the linear Fokker-Planck equations with respect to the mean of the state. The theoretical foundation of the probability propagator is briefly described as follows. The model may be originally constructed from the forward-Kolmogorov propagator, which has the following differential form:

$$\frac{\partial P ( ( x , t ) \vert ( {x}^{′} , {t}^{′} ) )}{\partial t} = A ( t ) P ( ( x , t ) \vert ( {x}^{′} , {t}^{′} ) ) \qquad [ 3 ]$$

where P((x, t)|(x′, t′)) is the probability that at time t the system will have state x given that at a previous time t′, the state x′ was observed. In general any function ρ(x) is to be propagated, A(t) may need to be determined such that

$$A ( t ) ρ ( x ) = {lim}_{Δ t -> 0} \frac{1}{Δ t} \int d {x}^{′} ( P ( x , t + Δ t \vert ( {x}^{′} , {t}^{′} ) ) - P ( ( x , t ) \vert ( {x}^{′} , {t}^{′} ) ) ρ ( {x}^{′} ) . \qquad [ 4 ]$$

The forward Kolmogorov propagator is a general integral partial differential propagator that generates general probability distributions depending on the input data, but may be impractical to compute for near real-time applications. A system according to embodiments may take the approach to linearize the forward Kolmogorov propagator with respect to the mean of the state in the form of the Fokker-Planck equation, a linear diffusion equation. Examples of the estimation of mean state may include an arithmetic mean or a weighted moving average mean. Letting x̅ₜ be the mean of the state at time t, Δxₜ is the difference between the current state and the mean of the state at time t, i.e. Δxₜ=xₜ−x̅ₜ. The Fokker-Planck equation is given below

$$\frac{\partial P}{\partial t} = {\sum }_{i , j} {a}_{ij} ( Δ {x}_{t} , t ) \frac{{\partial }^{2} P}{\partial {x}_{i} \partial {x}_{j}} + {\sum }_{k} {b}_{k} ( Δ {x}_{t} , t ) \frac{\partial P}{\partial {x}_{k}} + c ( Δ {x}_{t} , t ) P \qquad [ 5 ]$$

Subsequently, the above Fokker-Planck equation may be discretized similar to Kushner's finite element method (FEM). This may provide the probability propagator.

The incremental probabilistic model is continuously differentiable with respect to the parameters, and may be well suited for the marching algorithm for training. Also, the time increment, δ, is determined by the application (e.g., one minute, one hour, one day, etc.). An assumption may be made for each time increment the transitions from incremental state to incremental state can only change at most two elements of the state. For example, if the incremental state vector is at “low” incremental demand, it might transition to “medium” incremental demand, but it may not jump to “high” incremental demand (two levels) in one time increment δ. The Markov chain transition matrix is a “banded” matrix, intuitively, a wide diagonal matrix. It captures some interactions, for example, incremental demand might go up one level and incremental inventory might go down one level in one time increment δ. The number of levels and the time increment may be modified to achieve the desired tradeoff between accuracy and computation. The probability distribution generated by the propagator may be learned from the data, and no assumptions may be necessary contrary to conventional systems.

The model may be expressed as follows:

$${p}_{t}^{{h}_{t} , δ} ( Δ {x}_{t} , Δ {x}_{t} , {e}_{i} {h}_{t} ) = \frac{δ}{{h}_{t}^{2}} [ {a}_{ii} ( Δ {x}_{t} , t ) - {\sum }_{\begin{matrix}j \\ i \neq j\end{matrix}} {a}_{ij} ( Δ {x}_{t} , t ) + {e}_{i} {h}_{i}^{T} {S}_{i} ( Δ {x}_{t} , t ) ] + {Ext}_{i -} \\ if the {i}^{th} and only the {i}^{th} element of {h}_{t} is nonzero , \\ {p}_{t}^{{h}_{t} , δ} ( Δ {x}_{t} , Δ {x}_{t} + {e}_{i} {h}_{t} + {e}_{j} {h}_{t} ) = \frac{δ}{{h}_{t}^{2}} [ {a}_{ij}^{-} ( Δ {x}_{t} , t ) ] \qquad [ 6 ]$$

if the i^{th} element of h is positive and the j^{th} element is negative (and the remaining element is zero),

$${p}_{t}^{{h}_{t} , δ} ( Δ {x}_{t} , Δ {x}_{t} + {e}_{i} {h}_{t} + {e}_{j} {h}_{t} ) = \frac{δ}{{h}_{t}^{2}} [ {a}_{ij}^{+} ( Δ {x}_{t} , t ) ]$$

if the i^{th} and j^{th} elements of h are both positive or negative (and the remaining element is zero).

pₜ^{h}^{ₜ}^{,δ}(Δxₜ,y)=0, otherwise

where pₜ^{h}^{ₜ}^{,δ}(x, y) is the probability of states x and y occurring. Δxₜ=xₜ−x̅ₜ is the time step (for example, Δ may be one if the data occurs once per day), hₜ represents the step size or the amount of change in the state:

$${h}_{t} = {x}_{t} - {x}_{t - 1} = [ \begin{matrix}{Demand}_{t} - {Demand}_{t - 1} \\ {Inventory}_{t} - {Inventory}_{t - 1} \\ {Delivery}_{t} - {Delivery}_{t - 1}\end{matrix} ] \qquad [ 7 ]$$

eᵢ is a vector of zeros with a one at the i^{th} entry with i={1,2,3}, Extᵢ₋ is the external influence (set to zero for now). A linear model may be used to regress for the parameters to be determined. Hence,

aᵢⱼ(Δxₜ,t)=aᵢⱼ₀+aᵢⱼ₁Δxₜ+aᵢⱼ₂t [8]

Sᵢ(Δxₜ,t)=Sᵢ₀+Sᵢ₁Δxₜ+Sᵢ₂t. [9]

Since Δxₜ is a 3×1 vector, aᵢⱼ₁ and Sᵢ₁ may be defined as 1×3 vectors:

aᵢⱼ₁=[aᵢⱼ₁₁,aᵢⱼ₁₂,aᵢⱼ₁₃] [10]

Sᵢ₁=[Sᵢ₁₁,Sᵢ₁₂,Sᵢ₁₃]. [11]

Thus, following may be obtained:

aᵢⱼ₁Δx=aᵢⱼ₁₁Δx₁+aᵢⱼ₁₂Δx₂+aᵢⱼ₁₃Δx₃ [12]

Sᵢ₁Δx=Sᵢ₁₁Δx₁+Sᵢ₁₂Δx₂+Sᵢ₁₃Δx₃. [13]

The parameters to be estimated are 15 elements of Sᵢₖ, (k={0,1,2}) and the 60 elements of aᵢⱼₖ, aᵢⱼₖ⁻, aᵢⱼₖ⁺, (k={0,1,2}). Next, an optimization computation may be constructed with the parameters as decision variables which can be performed by using fast marching algorithm.

To optimize the parameters for the incremental probabilistic forecaster model, a maximum likelihood optimization computation may be constructed using the fast marching algorithm to solve this optimization.

P(T_{ss′})=P(xₜ=s, xₜ₊₁=s′) may be defined as the probability of transitioning from state xₜ to xₜ₊₁, where s is the current state and s′ is the state at the next time step. This probability can be written as a function of A and S, P(T_{ss′})=ƒ(A, S). Using maximum likelihood the goal is to solve the following optimization problem

max log P({A,S}|T_{ss′}). [14]

Using Bayes' theorem the expression may be written as:

$$P ( \{ A , S \} \vert {T}_{{ss}^{′}} ) = \frac{P ( {T}_{{ss}^{′}} \vert \{ A , S \} ) P \{ ( A , S \} )}{P ( {T}_{{ss}^{′}} )} , \qquad [ 15 ]$$

where P(T_{ss′}|{A, S}) is given by the probability propagator equations above, P({A, S}) can be assumed to be a uniform distribution and P(T_{ss′}) can be obtained from the data and may not affect the optimization program as it is independent of the parameters.

Then the formulation becomes

max Σ log P({A,S)}|T_{ss′}) [16]

s.t. 0≦pₜ^{h}^{ₜ}^{,δ}(Δxₜ,y)≦1 for all t [17]

Σpₜ^{h}^{ₜ}^{,δ}(Δxₜ,y)=1 for all t [18]

It should be noted that this computation may need to be performed for each day of the week. For example, the distribution of sales for a given product on Monday may differ from the distribution on Tuesday.

Using the Bayes' formula and substituting the discretized Fokker-Planck equation, the fast marching algorithm may be used for solving the above formulation. The gradients of the probabilities with respect to the parameters can be found. Initial conditions for the parameters are still needed to start the algorithm. In order to handle the constraints, Lagrange multipliers may be used. Thus, the expression becomes

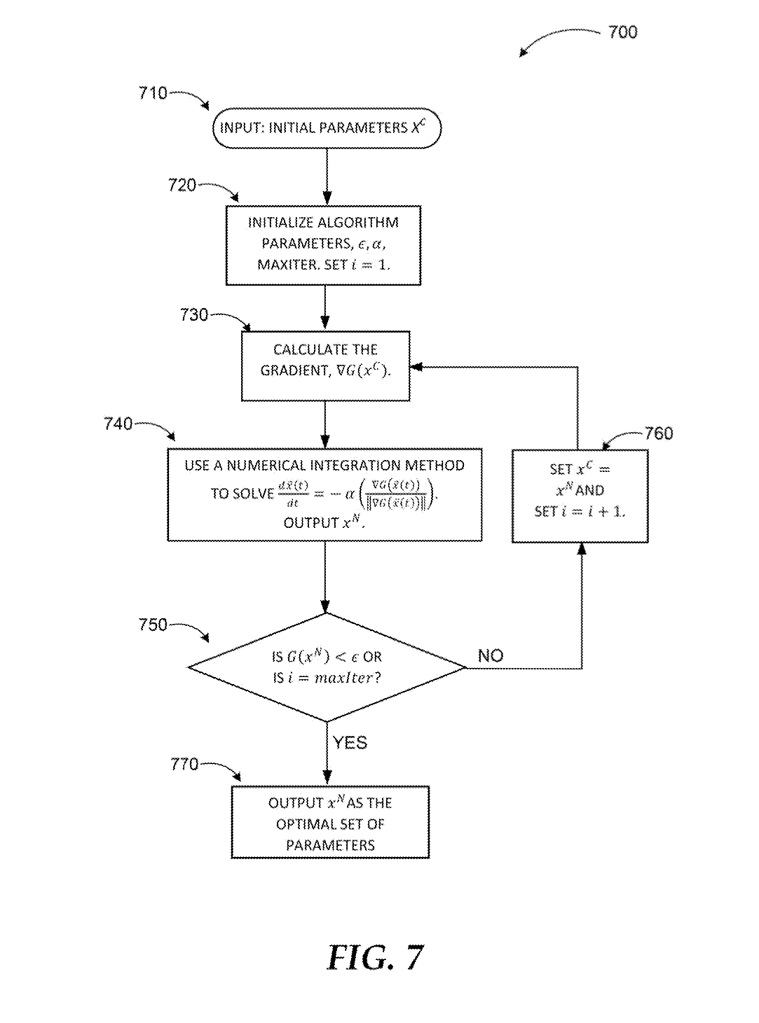

max Σ log P(T_{ss′}|{A,S})+log P({A,S})−λ(1−Σpₜ^{h}^{ₜ}^{,δ})²−μ(1−pₜ^{h}^{ₜ}^{,δ}), [19]

where λ and μ are Lagrange multipliers. It should be noted that there are multiple Lagrange multiplier variables in the formulation, one corresponding to each state, as the sum of the transition probabilities for each state is desired to sum to one. P({A, S}) may be assumed to be a uniform distribution, which means that this term does not affect the optimization. An example flow diagram for using a modified fast marching algorithm to solve equation [19] is shown and discussed in FIG. 7 below.

As mentioned above, x̅ₜ is the mean of the state at time t. The mean may be updated as the system loops through the data. Examples of the estimation of mean state may include an arithmetic mean or a weighted moving average mean.

Once the parameters are optimized, the new mean of the state may be predicted and incremental predictions made based on desired levels. As the probabilities are constructed based on the mean of the state, an acceptable range of hₜ may be selected and the probabilities added over all values of hₜ. Recalling that hₜ is the change in the state from t to t+1, the expected change may be determined relative to the mean, denoted Δ\tilde{x}, which may be added to x̅ₜ to obtain x̅ₜ₊₁, the mean of the state at the next time point.

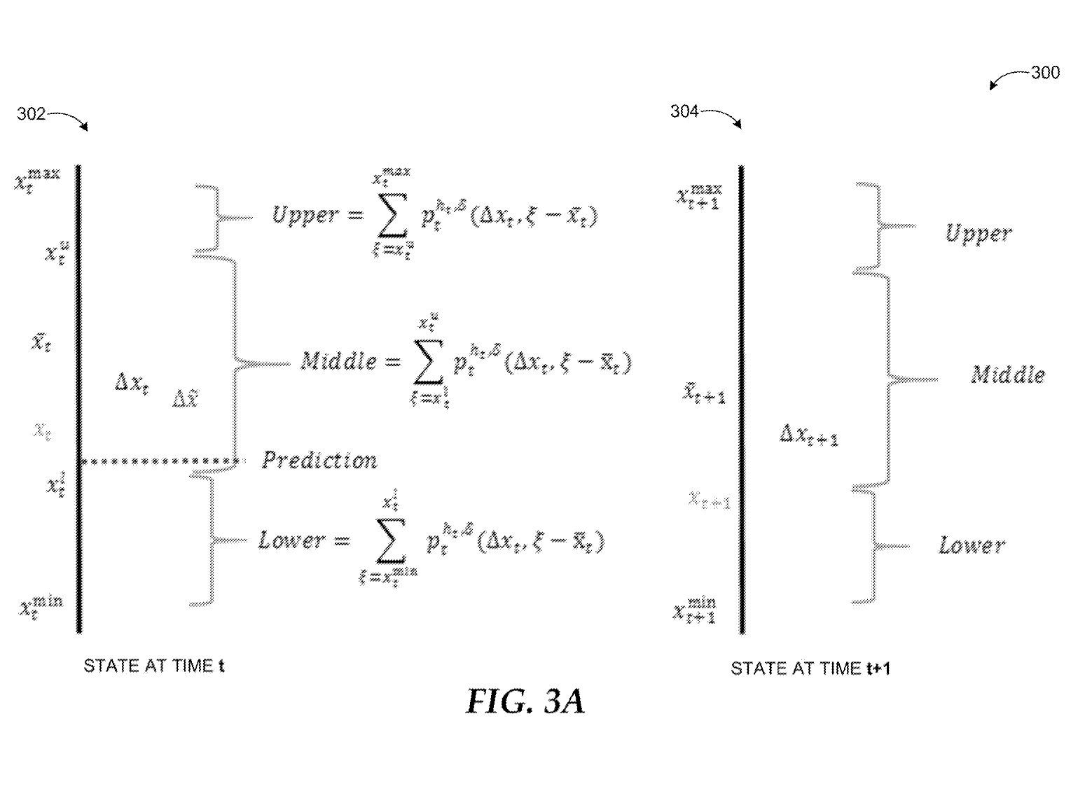

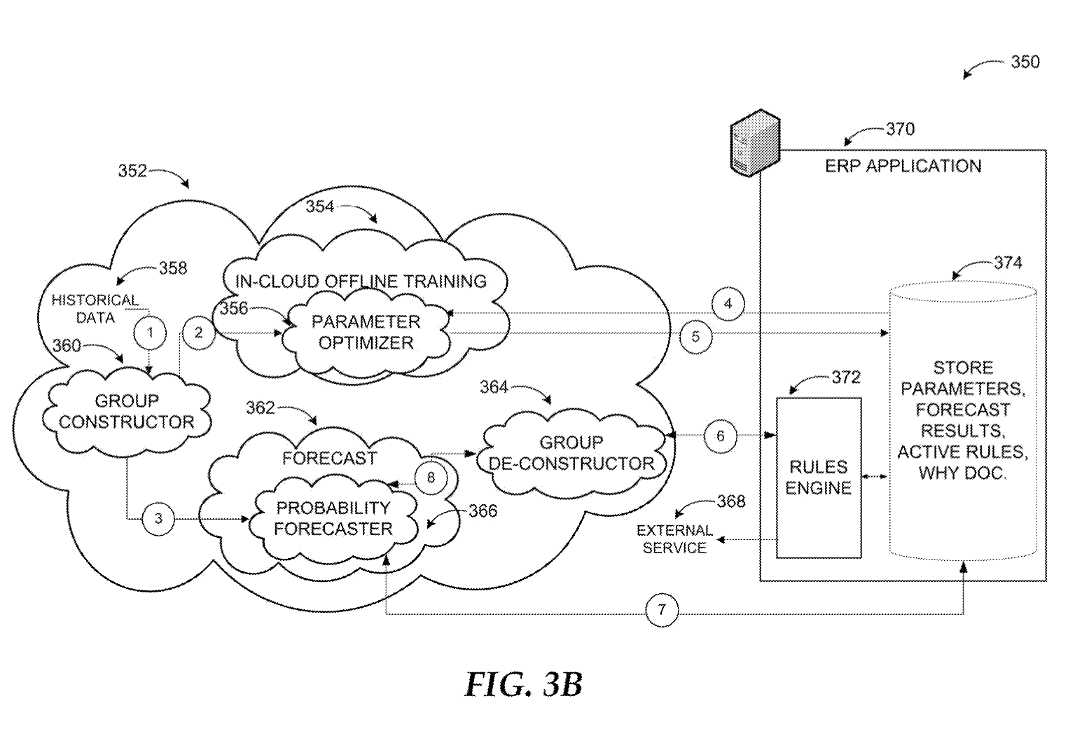

FIG. 3A illustrates example selection of boundaries at different states of a delivery system.

An upper and a lower bound may be selected on hₜ by using the maximum and minimum values of the observed data, xₜ^{max} and xₜ^{min}. The values of hₜ may be divided into three levels, (lower, middle and high). By summing the probabilities over the levels, a prediction may be made on the next incremental change.

In diagram 300, x̅ₜ is the mean of the state and xₜ is the current state for state at time t (302). The prediction, the Δ\tilde{x}, may provide which incremental level (lower, middle or upper), is expected to be in for the next time point (in this example, the middle increment closest to the mean). For state at time t+1 (304). x̅ₜ is the new mean of the state calculated from the new state xₜ₊₁. It should be noted that the three levels also change in size with the new mean.

Probability interpolation between levels may be computed as follows. Given non-conditional probability at different levels, a linear interpolation schema may be used to compute probability in-between levels. For example, given a non-conditional probability at upper level x^{upper} to be P(x^{upper}), and at middle level x^{middle} to be P(x^{middle}), the probability at in-between level may be determined as 0.3*x^{upper}+0.7*x^{middle} is 0.3*P(x^{upper})+0.7*(x^{middle}).

FIG. 3B illustrates an example of cloud implementation for offline training.

As shown in diagram 350, a demand forecast system in a cloud 352 may include an in-cloud offline training component 354 and a forecast component 362. Additionally, a group constructor 360 and a group de-constructor 364 may also be included. A parameter optimizer 356 within the in-cloud offline training component 354 may execute the fast marching algorithm as discussed herein. In an example operation, historical data 358 at individual item level may be provided (1) to the group constructor 360, which may provide (2) grouped historical data to the parameter optimizer 356. The group constructor 360 may also provide (3) grouped historical data and parameters to the probability forecaster 366 within forecast component 362.

An ERP application 370 may request (4) parameter training from the parameter optimizer 356 and receive (5) trained parameters in return storing them at storage 374. Probability forecaster 366 may exchange updated parameters (7) with the storage 374 and forecast results at group level (8) with the group de-constructor 364. The group de-constructor 364 may provide (6) forecast results at individual item level to the rules engine 372, which my save results of its execution at the storage 374. The rules engine may also receive historical data at individual item level from an external service 368.

Various components of a system according to embodiments such as the forecaster module may be executed on a variety of computing devices such as dedicated or shared servers (machines in datacenters), interconnected desktop or laptop computing devices, or even mobile computing devices such as vehicle mount or handheld computing devices.

The example scenarios and schemas in FIG. 1 through 7 are shown with specific components, data types, and configurations. Embodiments are not limited to systems according to these example configurations. Incremental parameter estimation for the probabilistic forecaster may be implemented in configurations employing fewer or additional components in applications and user interfaces. Furthermore, the example schema and components shown in FIG. 1 through 7 and their subcomponents may be implemented in a similar manner with other values using the principles described herein.

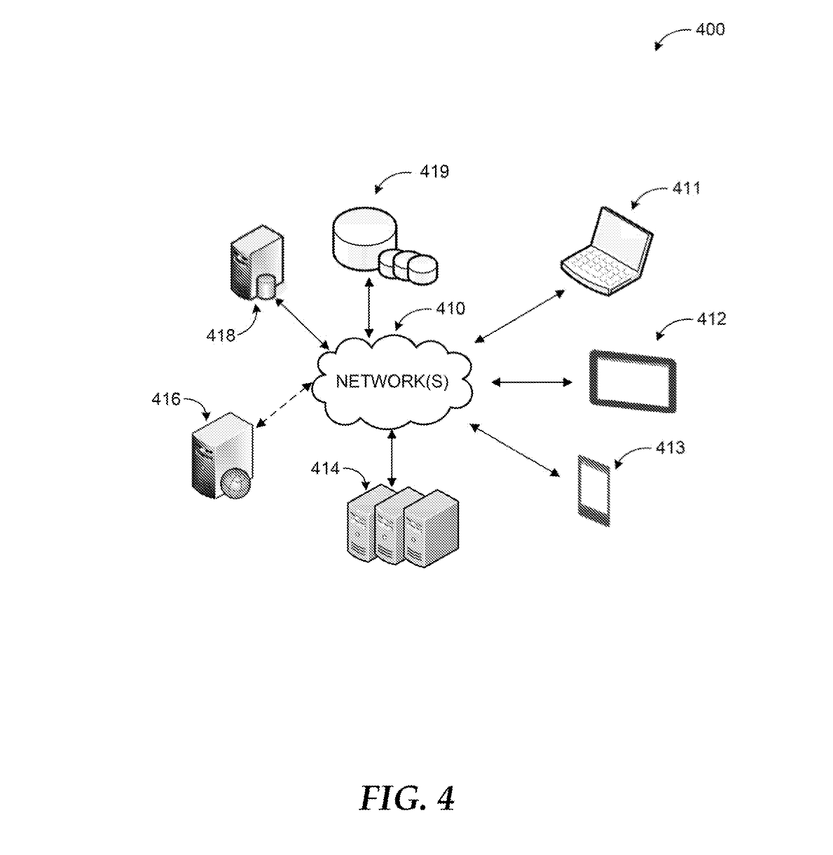

FIG. 4 is an example networked environment, where embodiments may be implemented.

Inventory management involves a retailer seeking to acquire and maintain a proper merchandise assortment while ordering, shipping, handling, and related costs are kept in check. It also involves systems and processes that identify inventory requirements, set targets, provide replenishment techniques, report actual and projected inventory status and handle all functions related to the tracking and management of material. This may include the monitoring of material moved into and out of stockroom locations and the reconciling of the inventory balances. It also may include analysis, lot tracking, cycle counting support, etc. Management of the inventories, with the primary objective of determining/controlling stock levels within the physical distribution system, functions to balance the need for product availability against the need for minimizing stock holding and handling costs.

Inventory proportionality is the goal of demand-driven inventory management. The primary optimal outcome is to have the same number of days' (or hours', etc.) worth of inventory on hand across all products so that the time of run-out of all products would be simultaneous. In such a case, there is no excess inventory, that is, inventory that would be left over of another product when the first product runs out. Excess inventory is sub-optimal because the money spent to obtain it could have been utilized better elsewhere, i.e. to the product that just ran out. The secondary goal of inventory proportionality is inventory minimization. By integrating accurate demand forecasting with inventory management, rather than only looking at past averages, a much more accurate and optimal outcome is expected. Integrating demand forecasting into inventory management in this way also allows for the prediction of the “can-fit” point when inventory storage is limited on a per-product basis.

As shown in a diagram 400, in an enterprise environment, inventory operations such as demand determination, inventory level management, forecasting, etc. may be managed through one or more applications as part of an enterprise resource planning (ERP) service executed on one or more servers. The system may be a cloud-based system and the applications may communicate over one or more network(s) 410, such as a cloud.

The ERP service and its components may be implemented via software executed over servers 414 or groups of servers 416. In other examples, the ERP service may be provided by a third party service or may include one or more web applications. The ERP service may store data associated with data in a data store 419 directly or through a database server 418.

The network(s) 410 may comprise any topology of servers, clients, Internet service providers, and communication media. A system according to embodiments may have a static or dynamic topology. The network(s) 410 may include multiple secure networks, such as an enterprise network, an unsecure network, or the Internet. The unsecure network may include a wireless open network. The network(s) 410 may also coordinate communication over other networks, such as Public Switched Telephone Network (PSTN) or cellular networks. Furthermore, the network(s) 410 may include multiple short-range wireless networks, such as Bluetooth, or similar ones. The network(s) 410 may provide communication between the nodes described herein. By way of example, and not limitation, the network(s) 410 may include wireless media. The wireless media may include, among others, acoustic media, RF media, infrared media, and other wireless media.

Many other configurations of the computing devices, the applications, the data sources, and the data distribution systems may be employed to provide incremental parameter estimation for the probabilistic forecaster in an inventory management system. Furthermore, the networked environments discussed in FIG. 4 are for illustration purposes only. Embodiments are not limited to the example applications, modules, or processes.

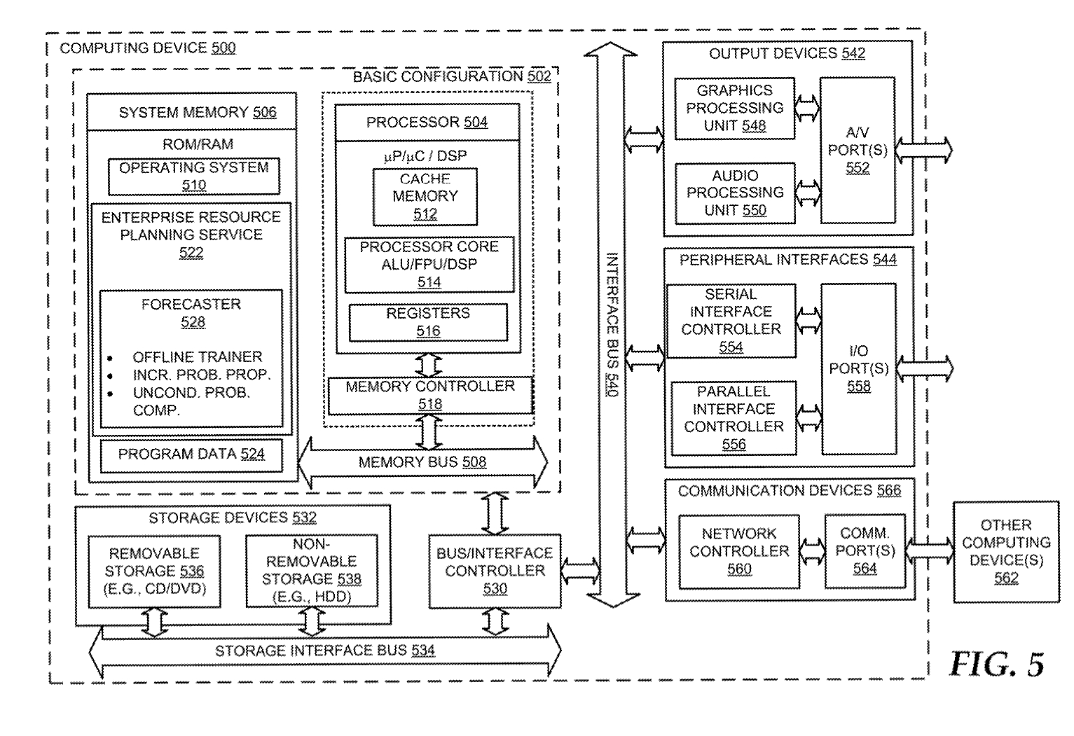

FIG. 5 illustrates a general purpose computing device, which may be configured to provide incremental parameter estimation for the probabilistic forecaster, arranged in accordance with at least some embodiments described herein.

For example, a computing device 500 may be a server used to provide an ERP service, as discussed herein. In an example of a basic configuration 502, the computing device 500 may include a processor 504 and a system memory 506. The processor 504 may include multiple processors. A memory bus 508 may be used for communication between the processor 504 and the system memory 506. The basic configuration 502 may be illustrated in FIG. 5 by those components within the inner dashed line.

Depending on the desired configuration, the processor 504 may be of any type, including, but not limited to, a microprocessor (μP), a microcontroller (μC), a digital signal processor (DSP), or any combination thereof. The processor 504 may include one more levels of caching, such as a level cache memory 512, a processor core 514, and registers 516. The processor core 514 may include an arithmetic logic unit (ALU), a floating point unit (FPU), a digital signal processing core (DSP Core), or any combination thereof. A memory controller 518 may also be used with the processor 504, or in some implementations, the memory controller 518 may be an internal part of the processor 504.

Depending on the desired configuration, the system memory 506 may be of any type including but not limited to volatile memory (such as RAM), non-volatile memory (such as ROM, flash memory, etc.), or any combination thereof. The system memory 506 may include an operating system 520, an ERP service 522, and program data 524. The ERP service 522 may include a forecaster module 526 with an offline trainer, an incremental probability propagator, and a computation engine for unconditional probability.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and data storage devices 532 via a storage interface bus 534. The data storage devices 532 may be removable storage devices 536, non-removable storage devices 538, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 506, the removable storage devices 536, and the non-removable storage devices 538 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and one or more communication devices 566) to the basic configuration 502 via the bus/interface controller 530. The one or more output devices 542 may include a graphics processing unit 548 and an audio processing unit 550, which may be configured to communicate to various external devices, such as a display or speakers via one or more A/V ports 552. The one or more peripheral interfaces 544 may include a serial interface controller 554 or a parallel interface controller 556, which may be configured to communicate with external devices, such as input devices (for example, keyboard, mouse, pen, voice input device, touch input device, etc.) or other peripheral devices (for example, printer, scanner, etc.) via one or more I/O ports 558. The one or more communication devices 566 may include a network controller 560, which may be arranged to facilitate communications with one or more other computing devices 562 over a network communication link via one or more communication ports 564. The one or more other computing devices 562 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 500 may be implemented as a part of a general purpose or specialized server, mainframe, or similar computer, which includes any of the above functions. The computing device 500 may also be implemented as a personal computer including both laptop computer and non-laptop computer configurations.

Example embodiments may also include methods to provide incremental parameter estimation for the probabilistic forecaster in an inventory management service. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

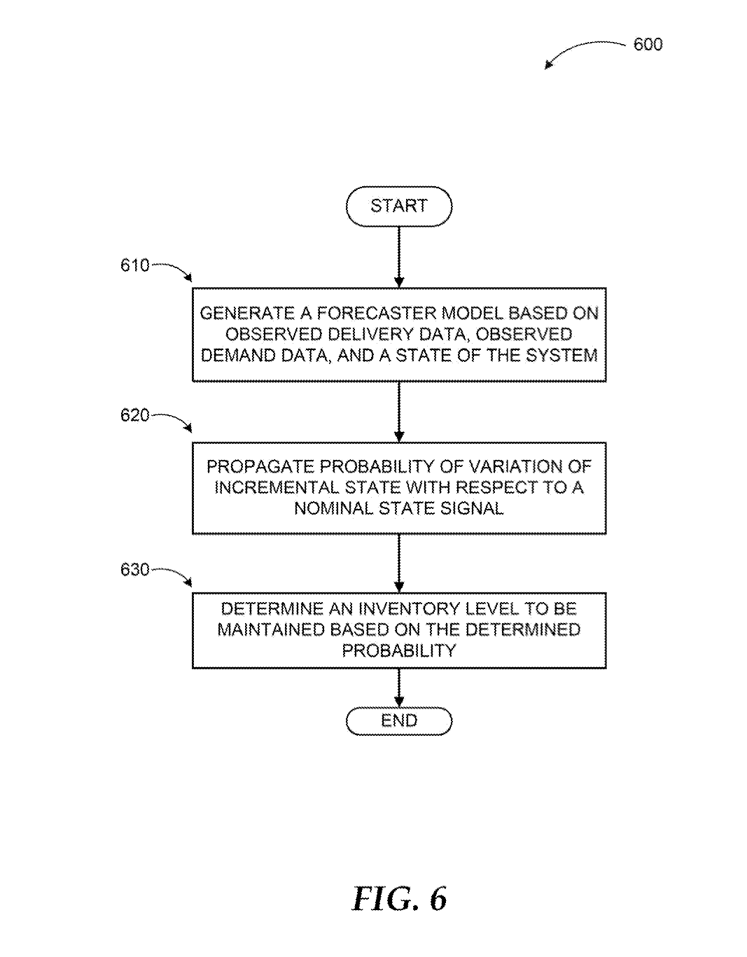

FIG. 6 illustrates a logic flow diagram for an example process to provide incremental parameter estimation for the probabilistic forecaster, arranged in accordance with at least some embodiments described herein.

A process 600 may be implemented by an enterprise resource planning service or an inventory management service and/or their components, where the components may be executed on one or more servers or other computing devices.

At operation 610, a forecaster module or application within the enterprise resource planning service or the inventory management service may generate a forecaster model based observed delivery data, observed demand data, and a state of the delivery system. The model may be derived from the discretized version of linear Fokker-Planck equations using maximum log-likelihood estimate with optimization through a fast marching algorithm.

At operation 620, the forecaster module may propagate a probability of a variation of the incremental state with respect to a nominal state signal. The nominal state signal may, for example, be an arithmetic mean and be updated periodically.

In one example, conditional incremental probabilities P(Δx(t)|Δx(t−δ)) may be constructed at time t over all incremental levels at (t−δ) (i.e. Δx(t−δ)). Given the constructed conditional incremental probabilities P(Δx(t)|Δx(t−δ)) and incremental probability P(Δx(t−δ)) computed at previous time (t−δ), the incremental probability P(Δx(t)) may be computed at time t. Next, given the nominal state signal x̅ at time (t−δ), x̅ may be computed at time t as follows, x̅(t)=[(t−δ)/t]*x̅(t−δ)+(δ/t)*[Δx̅(t)+x̅(t−δ)]=x̅(t−δ)+(δ/t)*Δx̅(t), where Δx̅(t) is expected value of Δx(t), i.e. Δx̅(t)=E(Δx(t)).

At operation 630, the forecaster module may determine an inventory level to be maintained based on the determined probability. The forecaster module or another component of the enterprise resource planning service or the inventory management service may then provide information associated with the inventory level to be maintained to one or more inventory systems for adjusting inventory operations such as delivery scheduling, replenishment, storage operations, and comparable ones.

The operations included in process 600 are for illustration purposes. An ERP service to provide incremental parameter estimation for the probabilistic forecaster, according to embodiments, may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

FIG. 7 illustrates a flowchart for an example modified fast marching algorithm.

For ease of notation, let x={A, S} be the set of parameters that are being optimized, so the optimization is

$${max}_{x} G ( x ) .$$

An example fast marching algorithm may start at operation 710, where starting point, x^{C}, acquired. Next, algorithm parameters are initialized at operation 720, and the gradient, ∇G(x^{C}), of all the parameters that are being optimized is computed at operation 730.

At operation 740, a numerical integration method may be used to solve the differential equation

$$\frac{d \tilde{x} ( t )}{d t} = - α ( \frac{∇ G ( \tilde{x} ( t ) )}{‖ ∇ G ( \tilde{x} ( t ) ) ‖} ) ,$$

where

$$‖ ∇ G ( \tilde{x} ( t ) ) ‖ = {max}_{i = 1 , … , n} ( \frac{\partial G ( \tilde{x} ( t ) )}{\partial {\tilde{x}}_{i} ( t )} )$$

The output may be a new set of parameters x^{N}. Next, a determination may be made, at decision operation 750, whether G(x^{N}) is less than some ε or whether a maximum number of iterations (maxIter) has been reached. If so, computations may be stopped and x^{N} output as the optimal set of parameters at operation 770. Otherwise, x^{C} may be set as x^{C}=x^{N} at operation 760 and computation returned to operation 730.

According to examples, a means for managing inventory operations is described. The means may include a means for generating a forecaster model based on observed delivery data, demand data, and a state of a delivery system, where the forecaster model is derived from a discretized version of the linear Fokker-Planck equations with respect to a mean of the state of the delivery system; a means for determining a probability of the state of the delivery system transitioning to a subsequent state of the delivery system based on an estimation of one or more parameters using a linear regression model; a means for determining an inventory level to be maintained based on the determined probability; and a means for providing information associated with the determined inventory level to be maintained to one or more inventory management systems.

According to some examples, a computing device to provide an inventory management service is described. The computing device may include a memory and one or more processors coupled to the memory, the one or more processors executing the inventory management service in conjunction with instructions stored in the memory. The inventory management service may include a communication module and a forecaster module. The communication module may be configured to receive data associated with one or more of a demand, a delivery, and an inventory level from one or more other computing devices. The forecaster module may be configured to generate a forecaster model based on observed delivery data, demand data, and a state of a delivery system managed by the inventory management service; propagate a probability of a variation of an incremental state with respect to a nominal state signal based on one or more parameters; and determine an inventory level to be maintained based on the determined probability.

According to other examples, the forecaster model may be derived from linear Fokker-Planck equations using a maximum likelihood estimate with an optimization through a fast marching computation. The forecaster model may further be derived from a discretized version of the linear Fokker-Planck equations with respect to the nominal state signal of the delivery system. The nominal state signal of the delivery system may include an arithmetic mean or a weighted moving average mean. The Fokker-Planck equations may be discretized using Kushner's finite element method (FEM). The forecaster module may be further configured to employ Lagrange multipliers to determine one or more initial constraints on the one or more parameters.

According to further examples, the forecaster module may be further configured to employ one Lagrange multiplier corresponding to each state of the delivery system such that a sum of transition probabilities for each state of the delivery system is one. The computing device may be a server within a cloud-based enterprise resource planning (ERP) system. The forecaster module may be further configured to construct the forecaster model initially from a forward-Kolmogorov propagator. The forecaster module may also be configured to linearize the forward Kolmogorov propagator with respect to a mean of the state of the delivery system in form of a linear diffusion equation. The model may be continuously differentiable with respect to the one or more parameters.

According to other examples, a method executed at one or more computing devices to manage inventory operations is described. The method may include generating a forecaster model based on observed delivery data, demand data, and a state of a delivery system, where the forecaster model is derived from a discretized version of the linear Fokker-Planck equations with respect to a mean of the state of the delivery system; determining a probability of the state of the delivery system transitioning to a subsequent state of the delivery system based on an estimation of one or more parameters using a linear regression model; determining an inventory level to be maintained based on the determined probability; and providing information associated with the determined inventory level to be maintained to one or more inventory management systems.

According to some examples, the method may also include updating the mean of the state of the delivery system each time the forecaster model loops through the observed delivery data and the demand data; upon optimization of the one or more parameters, incrementally predicting a new mean of the state of the delivery system based on desired levels of values of change for the state of the delivery system; and/or adjusting one or more of the levels of the values of change for the state of the delivery system and a time increment for performing predictions based on a desired tradeoff between an accuracy of the determined probability and a computational capacity. The values of change for the state of the delivery system may include a low level, a middle level, and a high level. The method may also include selecting an upper boundary and a lower boundary for the change of the state of the delivery system based on a maximum value and a minimum value of the observed delivery data.

According to further examples, a system to provide an enterprise resource planning service is described. The system may include a first computing device configured to execute a communication application, a second computing device configured to execute a forecasting application, and a third computing device configured to execute an inventory management application. The communication application may be configured to receive data associated with one or more of a demand, a delivery, and an inventory level from one or more other computing devices. The forecasting application may be configured to generate a forecaster model based on observed delivery data, demand data, and a state of a delivery system; determine a probability of the state of the delivery system transitioning to a subsequent state of the delivery system based on an estimation of one or more parameters using a linear regression model, where a probability distribution generated by the forecaster model is learned from at least the observed delivery data and the demand data; and determine an inventory level to be maintained based on the determined probability. The inventory management application may be configured to receive information associated with the inventory level to be maintained from the forecasting application and manage inventory operations based on the inventory level to be maintained.

According to yet other examples, the forecasting application executed on the second computing device may be further configured to derive the forecaster model from a discretized version of linear Fokker-Planck equations with respect to a mean of the state of the delivery system; and estimate the one or more parameters of the Fokker-Planck equations such that the forecaster model substantially fits observed data. The inventory operations may include one or more of ordering, shipping, handling, storing, setting targets, defining replenishment techniques, reporting actual and projected inventory status, and tracking inventory levels and deliveries.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide an inventory management service, the computing device comprising:
a memory;
one or more processors coupled to the memory, the one or more processors executing the inventory management service in conjunction with instructions stored in the memory, wherein the inventory management service includes:
a communication module configured to:
receive data associated with one or more of a demand, a delivery, and an inventory level from one or more other computing devices; and
a forecaster module configured to:
generate a forecaster model based on observed delivery data, demand data, and a state of a delivery system managed by the inventory management service;
propagate a probability of a variation of an incremental state with respect to a nominal state signal based on one or more parameters; and
determine an inventory level to be maintained based on the determined probability.

2. The computing device of claim 1, wherein the forecaster model is derived from linear Fokker-Planck equations using a maximum likelihood estimate with an optimization through a fast marching computation.

3. The computing device of claim 2, wherein the forecaster model is derived from a discretized version of the linear Fokker-Planck equations with respect to the nominal state signal of the delivery system.

4. The computing device of claim 3, wherein the nominal state signal of the delivery system includes one of an arithmetic mean and a weighted moving average mean.

5. The computing device of claim 3, wherein the Fokker-Planck equations are discretized using Kushner's finite element method (FEM).

6. The computing device of claim 1, wherein the forecaster module is further configured to employ Lagrange multipliers to determine one or more initial constraints on the one or more parameters.

7. The computing device of claim 6, wherein the forecaster module is further configured to employ one Lagrange multiplier corresponding to each state of the delivery system such that a sum of transition probabilities for each state of the delivery system is one.

8. The computing device of claim 1, wherein the computing device is a server within a cloud-based enterprise resource planning (ERP) system.

9. The computing device of claim 1, wherein the forecaster module is further configured to construct the forecaster model initially from a forward-Kolmogorov propagator.

10. The computing device of claim 9, wherein the forecaster module is further configured to linearize the forward Kolmogorov propagator with respect to a mean of the state of the delivery system in form of a linear diffusion equation.

11. The computing device of claim 1, wherein the model is continuously differentiable with respect to the one or more parameters.

12. A method executed at one or more computing devices to manage inventory operations, the method comprising:
generating a forecaster model based on observed delivery data, demand data, and a state of a delivery system, wherein the forecaster model is derived from a discretized version of the linear Fokker-Planck equations with respect to a mean of the state of the delivery system;
determining a probability of the state of the delivery system transitioning to a subsequent state of the delivery system based on an estimation of one or more parameters using a linear regression model;
determining an inventory level to be maintained based on the determined probability; and
providing information associated with the determined inventory level to be maintained to one or more inventory management systems.

13. The method of claim 12, further comprising:
updating the mean of the state of the delivery system each time the forecaster model loops through the observed delivery data and the demand data.

14. The method of claim 12, further comprising:
upon optimization of the one or more parameters, incrementally predicting a new mean of the state of the delivery system based on desired levels of values of change for the state of the delivery system.

15. The method of claim 14, further comprising
adjusting one or more of the levels of the values of change for the state of the delivery system and a time increment for performing predictions based on a desired tradeoff between an accuracy of the determined probability and a computational capacity.

16. The method of claim 14, wherein the values of change for the state of the delivery system include a low level, a middle level, and a high level.

17. The method of claim 14, further comprising:
selecting an upper boundary and a lower boundary for the change of the state of the delivery system based on a maximum value and a minimum value of the observed delivery data.

18. A system to provide an enterprise resource planning service, the system comprising:
a first computing device configured to execute a communication application, the communication application configured to:
receive data associated with one or more of a demand, a delivery, and an inventory level from one or more other computing devices; and
a second computing device configured to execute a forecasting application, the forecasting application configured to:
generate a forecaster model based on observed delivery data, demand data, and a state of a delivery system;
determine a probability of the state of the delivery system transitioning to a subsequent state of the delivery system based on an estimation of one or more parameters using a linear regression model, wherein a probability distribution generated by the forecaster model is learned from at least the observed delivery data and the demand data; and
determine an inventory level to be maintained based on the determined probability; and
a third computing device configured to execute an inventory management application, the inventory management application configured to:
receive information associated with the inventory level to be maintained from the forecasting application; and
manage inventory operations based on the inventory level to be maintained.

19. The system of claim 18, wherein the forecasting application executed on the second computing device is further configured to:
derive the forecaster model from a discretized version of linear Fokker-Planck equations with respect to a mean of the state of the delivery system; and
estimate the one or more parameters of the Fokker-Planck equations such that the forecaster model substantially fits observed data.

20. The system of claim 18, wherein the inventory operations include one or more of ordering, shipping, handling, storing, setting targets, defining replenishment techniques, reporting actual and projected inventory status, and tracking inventory levels and deliveries.
